(19) United States
(12) Patent Application Publication
(10) Pub. No.: US 2026/0309048 A1
(43) Pub. Date: Oct. 8, 2026

(54) SYSTEM FOR LOCKING A PLUG IN A COMPONENT OF AN AIRCRAFT TURBINE ENGINE, PREFERABLY A TURBINE ENGINE SHAFT

(71) Applicant: SAFRAN AIRCRAFT ENGINES, Paris (FR)

(72) Inventors: Thomas Jérôme George DUNOYER DE SEGONZAC, Moissy-Cramayel (FR); Thierry FACHAT, Moissy-Cramayel (FR); Patrick Jean Laurent SULTANA, Moissy-Cramayel (FR); Fabrice Marcel Noël GARIN, Moissy-Cramayel (FR)

(73) Assignee: SAFRAN AIRCRAFT ENGINES, Paris (FR)

(21) Appl. No.: 19/483,684

(22) PCT Filed: Jul. 23, 2024
(86) PCT No.: PCT/FR2024/051017

§ 371 Date: Nov. 12, 2025

(30) Foreign Application Priority Data
Jul. 26, 2023 (FR) FR2308062

(51) Int. Cl. F01D 25/00

(52) U.S. Cl. CPC F01D 25/00; F05D 2260/30

(57) ABSTRACT

A system for locking a plug on an component of an aircraft turbine engine, including a locking ring equipped with a projecting element, which, in a ring-locking position, is intended to be inserted into a first recess of the component, the first recess opening axially, the plug including a retaining finger intended to be inserted into a second recess of the component, the second recess adopting the form of a second notch circumferentially opening into the first recess. In addition, in the ring-locking position, the projecting element is intended to circumferentially cover, at least partially, the second recess housing the retaining finger of the plug.

### TECHNICAL FIELD

The invention relates to the field of systems for locking a plug in a component of an aircraft turbine engine, such as for example a turbojet engine or a turboprop.

Preferably, the invention relates to a system for locking such a plug, for example in a compressor shaft or a turbine shaft, but it is not limited to this preferred application.

### PRIOR ART

In the components of aircraft turbine engines, it is sometimes required to install a plug, for example in a hollow shaft to plug the space inside this shaft

Once in position and during operation of the turbine engine, the plug may be brought to support significant loads, in particular pressure loads

A system for locking the plug is therefore necessary to hold it in the initial position thereof on the turbine engine component. However, the solutions proposed in the prior art often prove to be complex, for example by implementing attachments such as circlips. In addition, this type of attachment may prove unsuitable for taking up significant loads that may be applied to the plug.

Moreover, the assembly and, above all, the disassembly of deformable components such as a circlip are sometimes complicated;

Finally, the design of the solutions of the prior art may require visual access for assembling the system for locking the plug. Yet, this visual access is not always possible within the extremely dense environment of a turbine engine.

Consequently, there is a need to improve the design of the plug locking systems of the prior art.

### DISCLOSURE OF THE INVENTION

To meet the need mentioned above, the first object of the invention is a system for locking a plug in a component of an aircraft turbine engine of axis (X), the component extending circumferentially about the axis (X), the system including a locking ring equipped with a projecting element, which, in a ring-locking position, is intended to be inserted into a first recess of the turbine engine component, the first recess opening axially, the plug including a retaining finger intended to be inserted into a second recess of the component, the second recess adopting the form of a second notch opening circumferentially in the first recess. In addition, in the ring-locking position in the turbine engine component, the projecting element of the ring is intended to circumferentially cover, at least partially, the second recess housing the retaining finger of the plug.

Thanks to the design of the invention, the extraction of the plug is simply prevented, and the system is able to support significant pressure loads on the plug.

In addition, the assembly of the locking system according to the invention may easily be performed blindly, that is to say without visual access to the zone of the turbine engine wherein the assembly is carried out.

The invention preferably comprises at least one of the following optional technical features, taken alone or in combination.

Preferably, the locking ring of the plug forms an anti-rotation ring of a coupling system of the turbine engine component with another turbine engine component, preferably two turbine engine shafts, said anti-rotation ring being intended to limit/prevent the rotation of a tightening nut of the coupling system, and the projecting element of the locking ring is intended to cooperate with the first recess provided on the turbine engine component, so as to form together a first rotational coupling device.

This preferred embodiment makes it possible for the ring to fulfill a plurality of distinct functions, by contributing both to the anti-rotation of the coupling nut, and to the locking of the plug. This simplifies the design and saves weight and costs.

Preferably, the locking ring includes two projecting elements, which, in a locking position of the locking ring, are respectively inserted into two first recesses of the component, the first recesses opening axially, the plug including two retaining fingers respectively configured to be inserted into the two second recesses of the turbine engine component, each of them opening circumferentially in one of the first recesses. In addition, in the locking position of the locking ring on the component, said at least two projecting elements of the locking ring circumferentially cover, at least partially, the two second recesses housing the retaining fingers.

Of course, the number of retaining fingers on the plug may be more than two, for example three, four, etc., preferably evenly spaced apart from one another in the circumferential direction.

Preferably, the projecting element is a finger, and the first recess of the turbine engine component is a first notch. Alternatively, the finger could be provided on the component of the turbine engine to be inserted into a notch of the ring, without departing from the scope of the invention.

Another object of the invention is an assembly for an aircraft turbine engine including a component of an aircraft turbine engine, a plug plugging a cavity of the component preferably at an axial end thereof, as well as a plug locking system as described above.

Preferably, the assembly further includes a system for coupling the component with another turbine engine component.

Preferably, the plug includes a body with an outer diameter substantially equal to an inner diameter of the cavity of the component to be plugged, and the retaining finger of the plug projects radially outward from this plug body.

Preferably, the second recess, which opens in the first recess, is a second circumferential notch made in one of the two sidewalls of the first recess.

Another object of the invention is an aircraft turbine engine, including at least one such assembly. For example, it may be a turbojet engine or a turboprop.

Finally, the object of the invention is a method for assembling a plug in a turbine engine component, with a system for locking the plug as described previously, the method including the following steps:
axially introducing the plug into a cavity of the component, such that the retaining finger of the plug is inserted into the first recess of the component;
rotating the plug so as to make the retaining finger thereof enter the second recess of the component;
axially moving the locking ring, so as to introduce the projecting element thereof into the first recess of the component, until the ring reaches the locking position thereof wherein the projecting element thereof circumferentially covers, at least partially, the second recess housing the retaining finger.

Other advantages and features of the invention will appear in the non-limiting detailed description below.

### BRIEF DESCRIPTION OF THE DRAWINGS

FIG. 1 is a longitudinal sectional view of a turbojet engine;

FIG. 2 is a longitudinal half-sectional view of a two-component coupling system of the turbojet engine shown in the preceding figure;

FIG. 3 is a cross-sectional view of the coupling system shown in FIG. 2, and corresponding to the section taken along line III-III of FIG. 2;

FIG. 4 is a partial perspective view of a tightening nut of the coupling system shown in FIGS. 2 and 3;

FIG. 5 is a partial perspective view of an anti-rotation ring of the coupling system shown in FIGS. 2 and 3;

FIG. 6 is a partial perspective view of an anti-rotation ring, according to an alternative embodiment;

FIG. 7 is a partial perspective view of an end of a shaft of the turbine engine, intended to be coupled by the coupling system shown in FIGS. 2 and 3;

FIG. 8 is a partial perspective view of the coupling system shown in FIGS. 2 and 3;

FIG. 9

[symbol]

FIG. 10

[symbol]

FIG. 12 are longitudinal half-sectional views of the coupling system shown in FIG. 2, in various successive states during a method for assembling this coupling system;

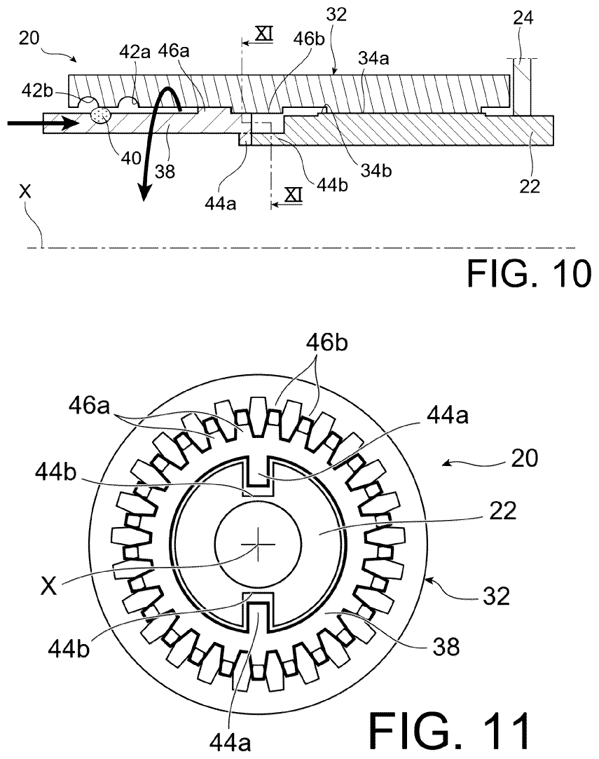

FIG. 11 is a cross-sectional view of the coupling system shown in FIG. 10, and corresponding to the section taken along line XI-XI of FIG. 10;

FIG. 13

[symbol]

FIG. 14 are cross-sectional views of the coupling system shown in the preceding figures, according to an alternative embodiment, and in various successive states during the method for assembling this coupling system;

FIG. 15 is a longitudinal half-sectional view of the coupling system similar to that shown in the preceding figures, and presented in the form of an alternative embodiment;

FIG. 16

[symbol]

FIG. 17

[symbol]

FIG. 18

[symbol]

FIG. 19 are partial sectional views of the coupling system according to yet another alternative embodiment, in various successive states during the method for assembling this coupling system;

FIG. 20 is a partial perspective view of a system for locking a plug of a component of the turbojet engine, this locking system being integrated into the coupling system shown in the preceding figures;

FIG. 21 is an axial view of the plug shown in the preceding figure;

FIG. 22

[symbol]

FIG. 23

[symbol]

FIG. 24 are partial perspective views of the locking system shown in FIG. 20, in various successive states during a method for assembling this locking system;

FIG. 25 is a partial sectional view of the locking system, in the state thereof as shown in FIG. 23;

FIG. 26 is a partial sectional view of the locking system, in the state thereof as shown in FIG. 24;

FIG. 27 is a partial sectional view of the locking system, in the state thereof at the end of the method for assembling this system.

### DETAILED DESCRIPTION OF THE INVENTION

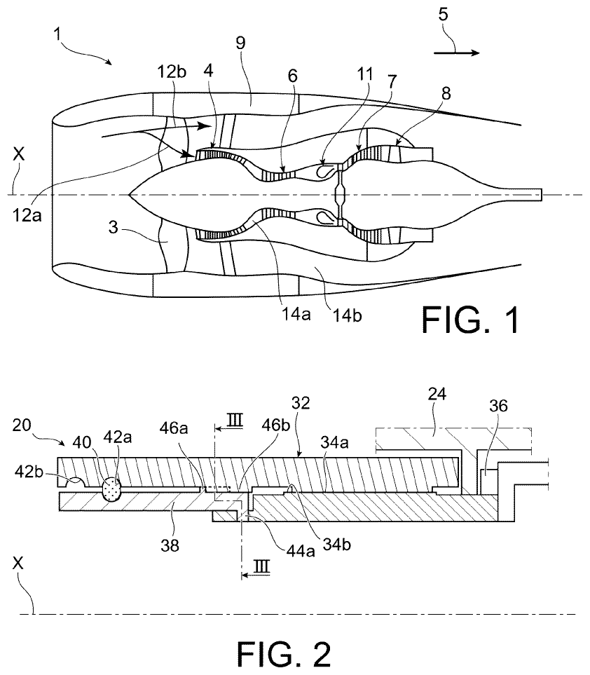

With reference firstly to FIG. 1, an aircraft turbine engine 1 is shown, according to a preferred embodiment of the invention. This is a twin-spool turbofan. Nevertheless, it could be a turbine engine of another type, for example a turboprop engine, without departing from the scope of the invention.

The turbine engine 1 has an axis X about which the various components thereof extend, this axis being called the longitudinal axis of the turbine engine. It includes, from upstream to downstream in a main direction 5 of flow of gases through this turbine engine, a fan 3, a low-pressure compressor 4, a high-pressure compressor 6, a combustion chamber 11, a high-pressure turbine 7 and a low-pressure turbine 8.

Conventionally, after passing through the fan, the air splits into a central primary flow 12a and a secondary flow 12b that surrounds the primary flow. The primary flow 12a flows into a main gas circulation path 14a passing through the compressors 4, 6, the combustion chamber 11 and the turbines 7, 8. The secondary flow 12b in turn flows in a secondary flow path 14b radially outward delimited by a motor casing, surrounded by a nacelle 9.

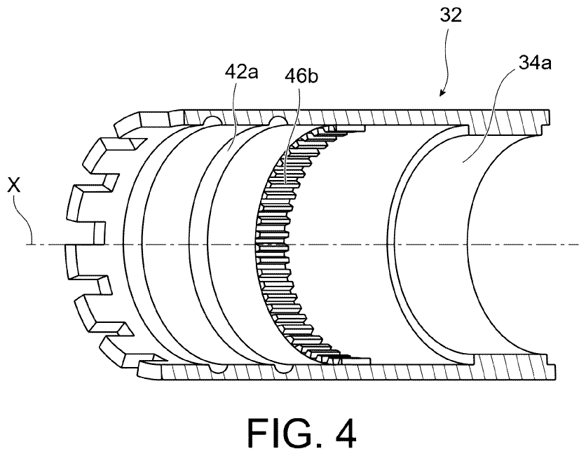

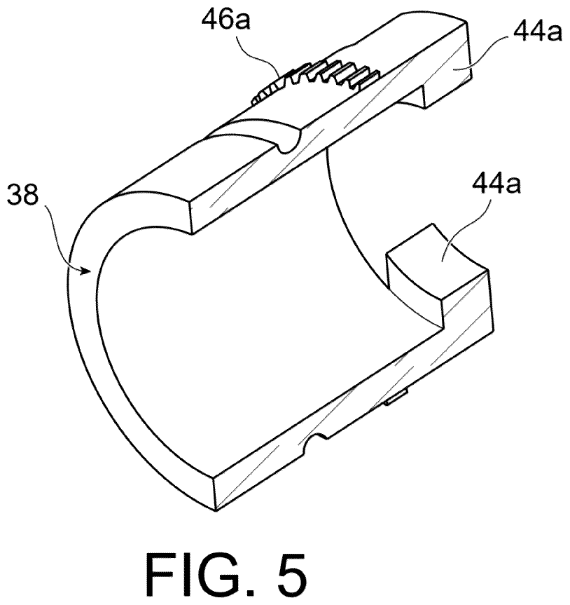

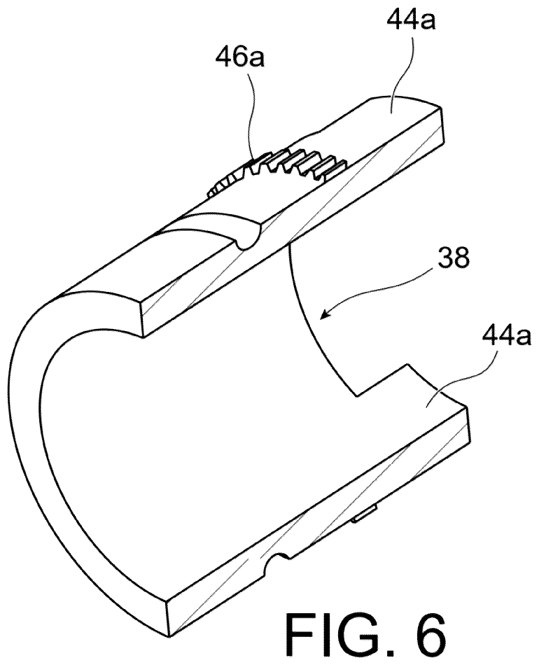

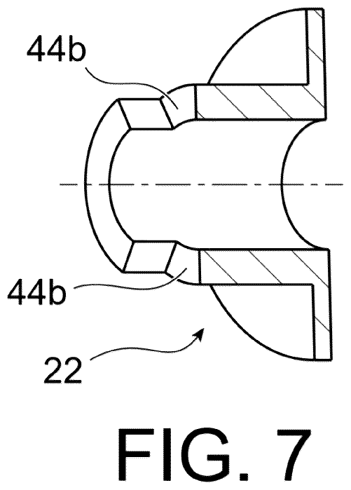

FIGS. 2 to 8 show a system 20 for coupling two rotating components of the turbojet engine 1, having the same axis of rotation X. Here, it is a first shaft 22 corresponding to a shaft of the low-pressure turbine, and a second shaft 24 corresponding to a shaft of the low-pressure compressor. These two shafts 22, 24 are hollow, and the upstream end of the first shaft 22 is inserted into the downstream end of the second shaft 24, so as to be translationally and rotably coupled in the axial direction, via the system 20. The two shafts 22, 24, concentric and centered on the axis X, form an assembly 30 with the coupling system 20 thereof. A plurality of assemblies of this type may be provided within the turbojet engine, with coupled components that may indifferently belong to various modules of the turbojet engine, among which the fan, the compressors, the combustion chamber, or the turbines.

The coupling of components having large diameters, and the visual access of which to the coupling zone is limited or even null, is preferred here. This is particularly the case of the architecture shown partially in FIG. 2, showing the system 20 in an assembled state, wherein the two shafts 22, 24 are coupled.

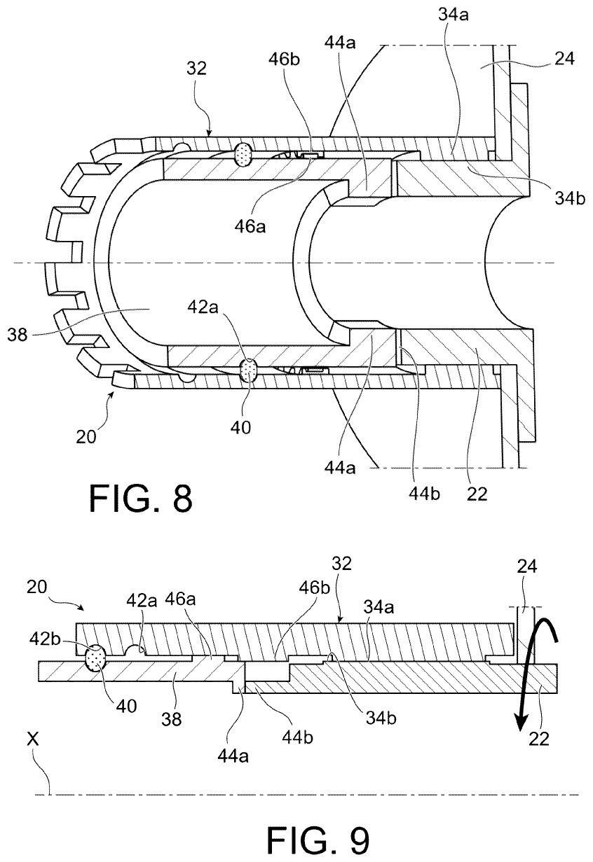

The coupling system 20 firstly comprises a nut 32 for tightening the two shafts, this nut being centered on the axis X and provided with a first thread 34a, or nut thread, cooperating with a second thread 34b, or first component thread, applied on an outer surface of the first shaft 22. As can be seen in FIGS. 2 and 8, in the assembled state of the coupling system 20, the downstream end of the nut 32 exerts an axial force on the second shaft 24, and more precisely on an internal shoulder thereof. This axial force pushes the second shaft 34 downstream against an external shoulder of the first shaft 22, with an axial shim 36 possibly interposed between the two shoulders, as has been shown by way of example in FIG. 2. The axial tightening intensity of the nut is sufficient to generate the desired coupling between the two shafts 22, 24.

The system 20 also comprises an anti-rotation ring 38 intended to limit/prevent the rotation of the nut 32, relative to the first shaft 22, in the assembled state of the system 20.

The anti-rotation ring 38 is centered on the axis X, being arranged at least partially internally in the nut 32, and being able to be moved axially relative to the latter, in different axial positions. In FIGS. 2 and 8, the anti-rotation ring 38 adopts the most downstream position thereof relative to the nut 32, corresponding to a final coupling position of the shafts. It is held there by a snap ring 40 or a similar retaining element, carried by the ring 38 and cooperating with a groove 42a opposite it, applied on the inner surface of the nut 32 upstream of the first thread 34a.

In the final coupling position of the ring 38, it is thus retained axially with respect to the nut 32, thanks to the snap ring 40, or any other translational stopping system associated with the ring. In this position, a first rotational coupling device is provided, as well as a second rotational coupling device, both in active coupling configuration.

The first rotational coupling device consists of first rotational coupling members 44a produced on the downstream end of the ring 38, and by first complementary rotational coupling members 44b, provided on the upstream end of the first shaft 22. Here, these are preferably finger-notch assemblies, the fingers 44a being preferably provided on the ring 38, and the notches 44b on the first shaft 22, even if a reverse solution may be envisaged. The notches 44b are also referred to as first notches 44b.

The number of these finger-notch assemblies is preferably less than four, for example three, or two as in the figures. In this case, the two fingers 44a are preferably diametrically opposite, as are the corresponding notches 44b thereof on the upstream end of the first shaft 22, these notches opening axially upstream.

The fingers 44a, provided at the downstream end of the ring 38, project axially downstream and radially inward as shown in FIGS. 2, 5 and 8, or they project only axially downstream, as shown in the alternative embodiment of FIG. 6.

The second rotational coupling device consists of second rotational coupling members 46a produced on the outer surface of the ring 38, and of second complementary rotational coupling members 46b, provided on the inner surface of the nut 32. Here, these are preferably splines 46a, 46b cooperating with each other, in the form of two concentric annular rows of splines. Each annular row of splines 46a, 46b may be uninterrupted over 360°, or extend only over an angular sector less than 360°, or extend over several angular sectors circumferentially spaced apart from one another. The number of splines per annular row is high, for example greater than twenty, thirty or forty. The number of splines is preferably the same for each of the two annular rows of splines, and this number is strictly greater than that of the number of notches and of the number of fingers.

Each spline extends radially, in the conventional form of a tooth, and more precisely radially outward for the splines 46a, and radially inward for the splines 46b.

One of the particularities lies in the fact that the first splines 46a are axially spaced apart from the fingers 44a, upstream. Indeed, there is preferably no axial overlapping zone between these elements 46a, 44a.

FIGS. 9 to 12 illustrate the method for assembling the coupling system 20 on the two shafts 22, 24.

Firstly, the system 20 is placed on the first shaft 22, such that the nut 32 surrounds the upstream end of this shaft, then tightening of this nut 32 is carried out via the first and second threads 34a, 34b. The objective of this tightening is to axially press the first shaft 22 against the second shaft 24, by pressing the downstream end of the nut against the second shaft 24. The tightening torque applied to the nut 32 corresponds to a minimum torque to ensure the desired coupling of the two shafts. This step is shown schematically in FIG. 9. During this step, the ring 38 is held in an upstream inactive position, known as the non-coupling position, where it is retained axially relative to the nut 32 via the snap ring 40 which cooperates with another groove 42b on the inner surface of the nut, arranged upstream of the groove 42a.

The next step is shown in FIGS. 10 and 11. It consists in rotating along the X axis of the ring 38 relative to the fixed nut 32, as well as translating it downstream. The rotation of the ring is used to match the fingers 44a with the notches 44b, after which an axial introduction of the fingers may be performed in these same notches. This axial movement of the ring leads indeed to bringing the anti-rotation ring 38 into a provisional axial position relative to the nut, thus placing the first coupling device 44a, 44b in rotation in the coupling configuration thereof. However, the axial movement of the ring 38 is normally stopped by the lack of matching between the splines 46a, 46b, as shown in FIG. 11 wherein it is shown that the first splines 46a are not aligned with inter-spline spaces on the other row of second splines 46b, and vice versa. As a result, in the provisional axial position of the ring 38, the second rotational coupling device 46a, 46b remains in a non-coupling configuration. During this step, the rotation and the translational force on the ring 38 can be exerted simultaneously, in particular when these actions are performed blindly in the zone for assembling the turbojet engine.

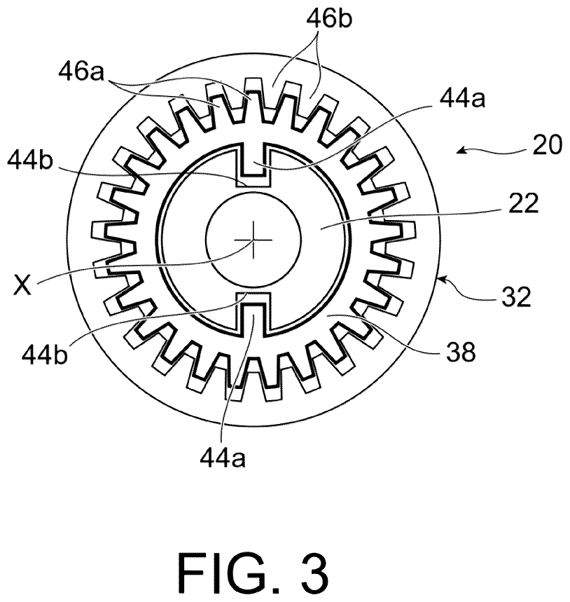

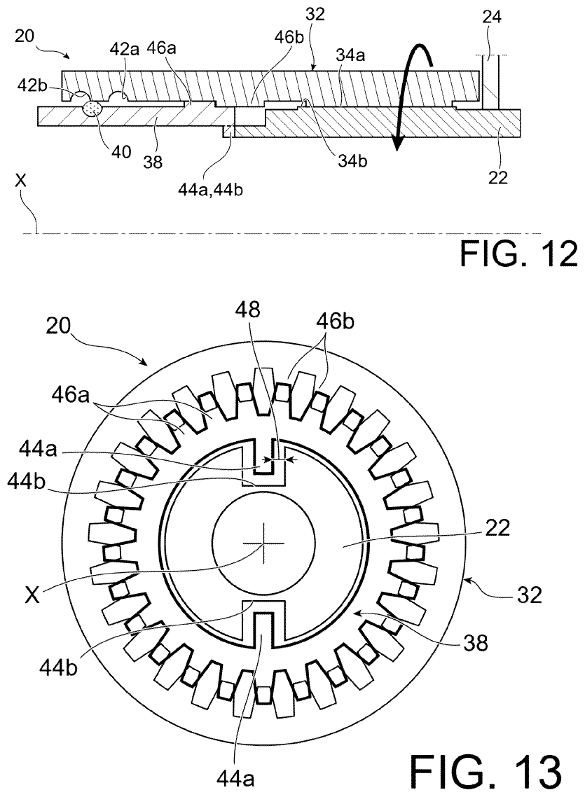

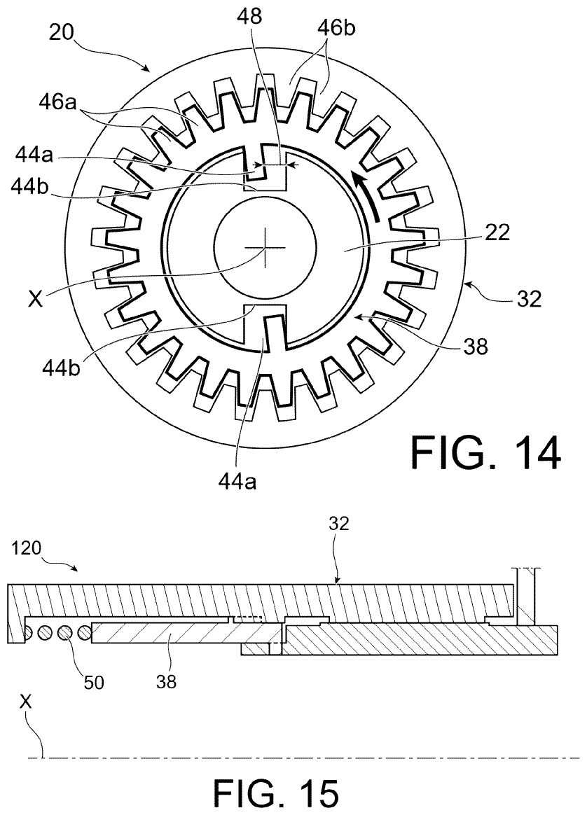

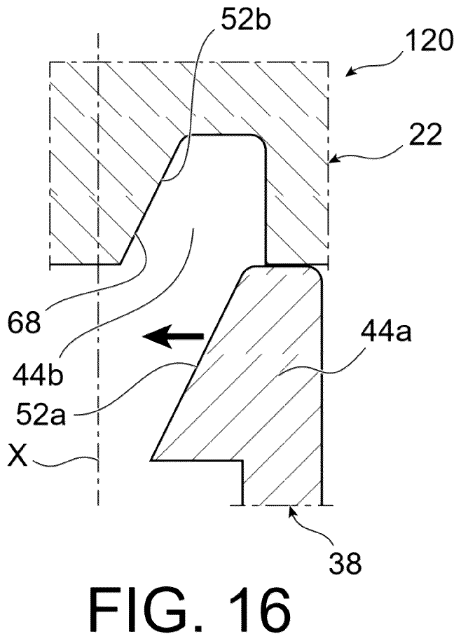

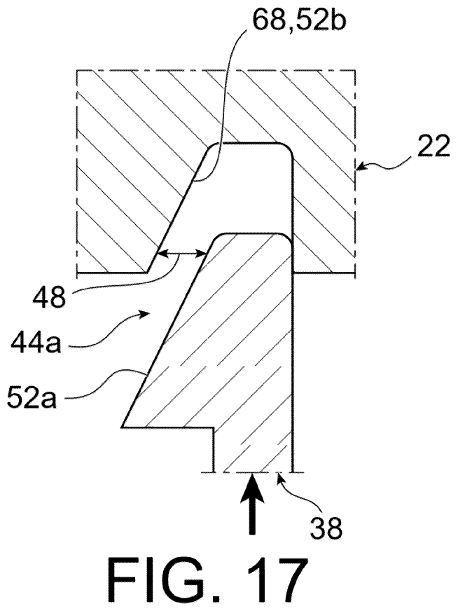

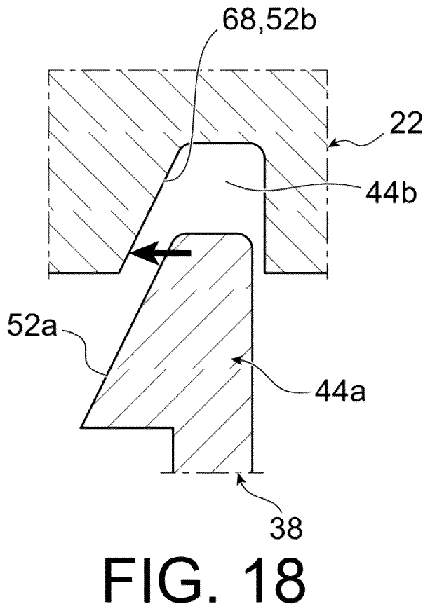

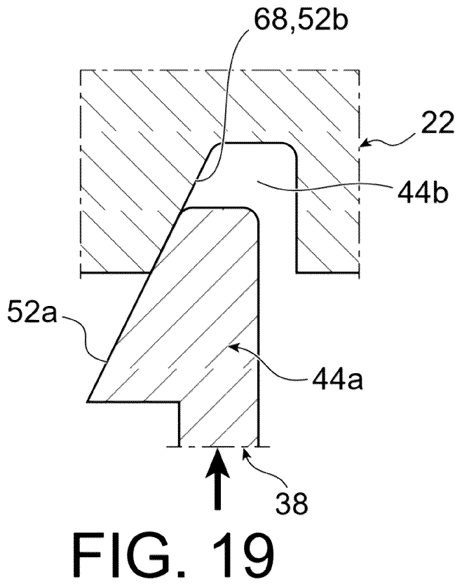

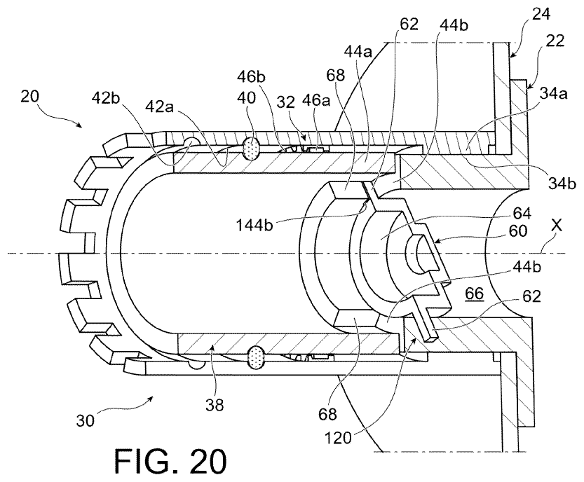

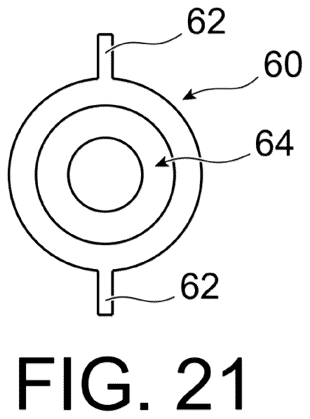

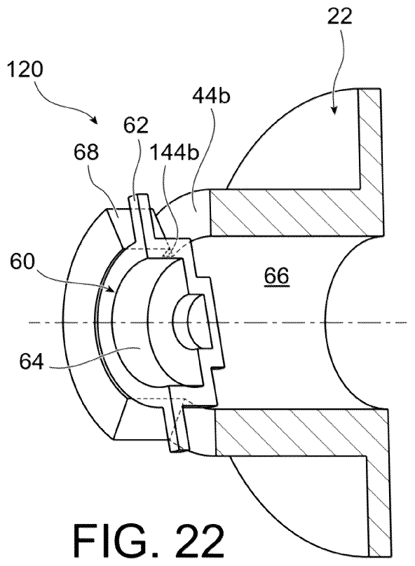

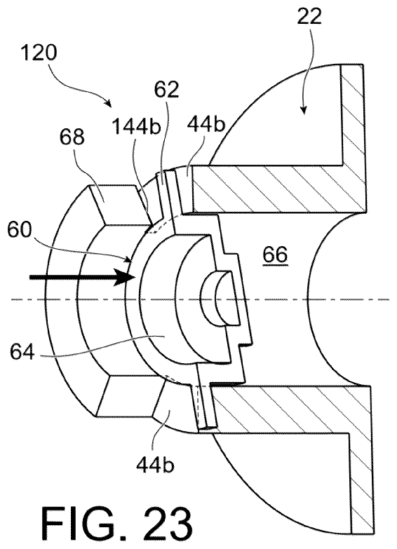

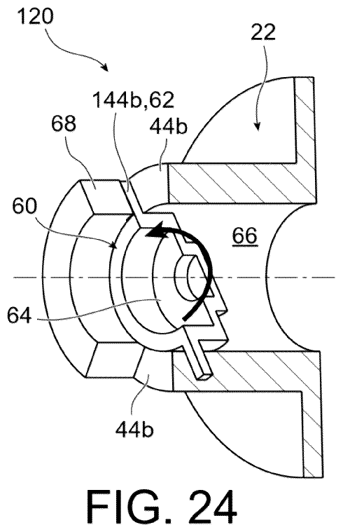

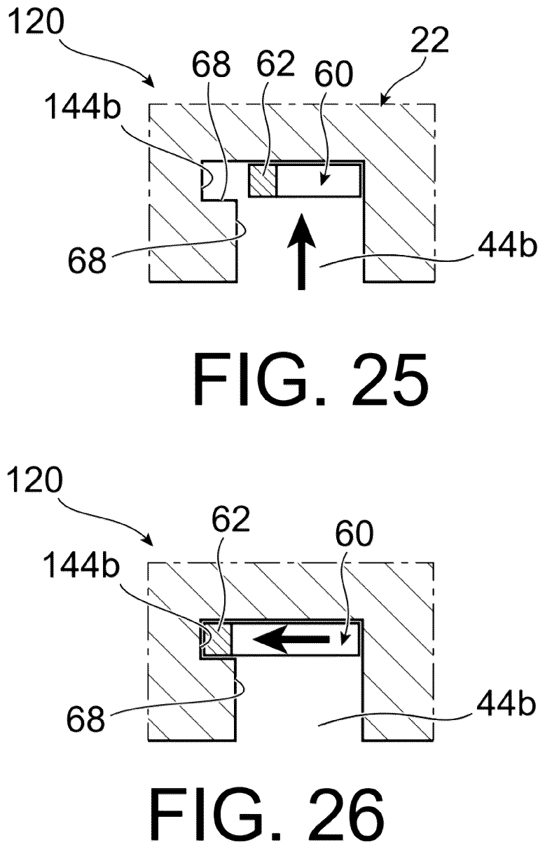

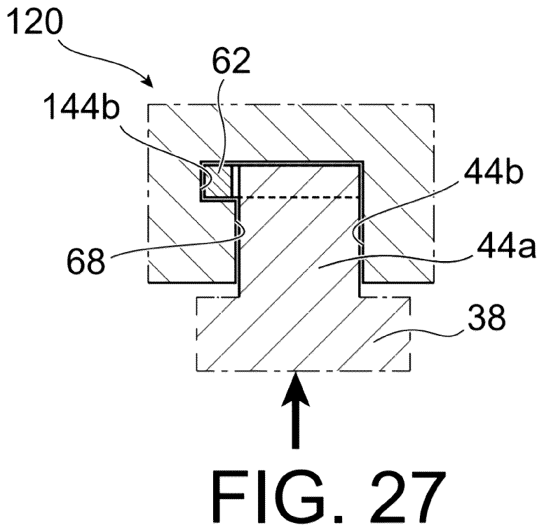

To achieve the desired matching between the splines 46a, 46b, shown particularly in FIG. 3, the nut 32 is tightened again on the second shaft 22. An over-torque is thus applied to the nut, with intensity remaining measured, until the desired matching between the splines 46a, 46b is obtained. This step aiming to apply an over-torque on the nut 32 is shown schematically in FIG. 12.

The pitch of the splines being lower than that of the notches, the rotation of the nut to be applied to make the sought matching possible between these splines, and the resulting over-torque, remain advantageously low.

Subsequently, a new axial movement of the ring 38 relative to the nut 32 is carried out, from the provisional axial position thereof to the final axial coupling position thereof, so as to make the splines 46a, 46b cooperate together as shown in FIG. 2. Here also, it is noted that the rotation of the nut 32 and the application of the translational force on the ring 38 can be exerted simultaneously, in particular when these actions are performed blindly in the zone for assembling the turbojet engine.

At the end of this step, the second rotational coupling device 46a, 46b is in the coupling configuration thereof, due to the cooperation between the splines. Similarly, the first rotational coupling device 44a, 44b remains in the coupling configuration thereof, after the fingers 44a thereof have been further inserted into the respective notches 44b thereof, following the additional axial movement of the ring 38 relative to the nut 32.

During this additional movement of the ring 38, the snap ring 40 is inserted into the groove 42a of the ring, thus ensuring the translational locking thereof. This makes it possible to maintain the entire system 20 in an assembled state, ensuring the translational and rotational coupling of the two shafts 22, 24, without risk of loosening the nut 32.

FIGS. 13 and 14 show an alternative embodiment, the design of which advantageously does not require the application of an over-torque on the nut, for finalizing the assembly of the coupling system 20.

This alternative embodiment has many technical features in common with the embodiment shown in FIGS. 2 to 12, and moreover, in the Figures, the elements that bear the same numerical references correspond to identical or similar elements.

In the alternative embodiment of FIGS. 13 and 14, the existence, in the provisional axial position of the ring 38, of a circumferential clearance 48 between each finger 44a and the corresponding notch 44b thereof is shown. This arrangement allows, by partial or total consumption of the clearance 48, sufficient angular clearance of the ring 38 relative to the nut 32 remaining fixed, to make it possible for the splines 46a, 46b to be matched, always in the circumferential direction. After such an operation, the coupling system 20 adopts a state as shown in FIG. 14. In this respect, it is noted that the circumferential direction, relative to the X axis, also corresponds to the tangential direction.

As indicated previously, the sought matching between the splines 46a, 46b allows the axial movement of the anti-rotation ring 38, from the provisional axial position thereof to the final axial coupling position thereof.

It is noted that a hybrid solution is also possible, wherein the matching of the splines 46a, 46b is obtained on the one hand thanks to the rotation of the ring 38 while consuming the aforementioned clearance 48, and on the other hand thanks to the application of a slight over-torque on the nut 32.

Another alternative embodiment is shown in FIG. 15, which provides elastic return means, such as one or more springs 50 arranged axially between the nut 32 and the anti-rotation ring 38. The spring 50 makes it possible to force the ring 38 axially downstream relative to the nut 32, and it is therefore able to generate the axial forces required for the passage of the ring 38 from the most upstream position thereof to the provisional axial position thereof, then from this provisional axial position to the final axial coupling position thereof.

This principle also makes it possible to hold the ring 38 in the final axial coupling position thereof, such that the spring stop means are no longer necessarily required.

FIGS. 16 to 19 show various states of the coupling system 20 according to yet another alternative embodiment, wherein each finger 44a and the corresponding notch 44b thereof have inclined circumferential stop surfaces, forming an angle with respect to the axial direction. In other words, each of these two surfaces 52a, 52b forms a non-zero value angle with the axial direction, parallel to the X axis.

The inclined circumferential stop surfaces 52a, 52b are shown in FIG. 16. They are parallel or substantially parallel, and respectively consist of a sidewall of the finger 44a, and of a sidewall 68 of the notch 44b. The inclination of the circumferential stop surface 52b of the notch 44b is such that it flares circumferentially going axially upstream. Conversely, the inclination of the circumferential stop surface 52a of the finger 44a is such that the latter narrows circumferentially going axially downstream.

The position of FIG. 16 corresponds to that of FIG. 9, wherein the finger 44a is not yet matching with the associated notch 44b thereof. When such a matching is achieved after rotating the ring 38, under the action of the operator or of the spring 50, the finger 44a is partially introduced into the notch 44b, as has been shown schematically in FIG. 17. The axial introduction is stopped by the stop between the splines. The circumferential clearance 48 observed between the inclined circumferential stop surfaces 52a, 52b may then be consumed, partially or totally by rotating the ring 38, in order to match these same splines (not shown in FIGS. 16 to 19). This step is shown schematically in FIG. 18. Subsequently, when the matching between the splines is obtained, the ring 38 is axially moved up to the final axial coupling position thereof, under the effect of the spring 50. This position is reached when the circumferential stop surfaces 52a, 52b come into contact with one another as shown in FIG. 19, this contact being preferably superficial.

Due to the inclination of the contact surfaces 52a, 52b, the finger 44a in abutment, on the sidewall of the notch 44b, exerts an inclined force on the shaft 22 with a circumferential component. This component has a direction such that the finger 44a forces the second shaft 22 in a direction of rotation causing the nut 38 to tighten more on this shaft 22.

FIG. 20 shows the assembly 30 including the system 20 for coupling the two shafts 22, 24, but also a system 120 for locking a plug 60 in the first shaft 22. Indeed, the plug 60 is assembled at the upstream end of the first shaft 22, at or near the first rotational coupling device 44a, 44b. This plug 60 is used to seal, upstream, the hollow space 66 inside the shaft 22, centered on the axis X. This plug 60 may be brought to support significant loads, in particular pressure loads, to which the locking system 120 must be able to withstand.

In the embodiment of FIG. 20, the system 120 for locking the plug as well as the system 20 for coupling the two shafts are thus combined within the assembly 30, and they share common components in order to present a compact overall design, of lower mass, and of reduced cost.

Nevertheless, it is noted that the locking system 120 according to the invention could be implemented in another environment of the turbojet engine, not necessarily in association with a coupling system as described previously, and possibly on a component other than a shaft.

Still with reference to FIG. 20, the locking system 120 includes the anti-rotation ring 38, which therefore here fulfills the additional function of locking the plug 60. Consequently, in the remainder of the description, this ring 38 will therefore be referred to as the locking ring.

The locking ring 38 is, as mentioned previously, equipped with projecting elements formed by the fingers 44a. In a ring-locking position 38, corresponding to the final axial coupling position thereof described above, the fingers 44a are respectively inserted into first recesses of the shaft 22, corresponding to the first notches 44b. Nevertheless, other forms could be adopted for the projecting elements 44a and the first recesses 44b, without departing from the scope of the invention.

One of the particularities here lies in the fact that the plug 60 comprises one or more retaining fingers 62, the number thereof being preferably identical to that of the first notches 44b, as well as the arrangement thereof. Thus, two retaining fingers 62 are provided on a plug body 64, diametrically opposite. In this respect, it is noted that the body 64 of the plug has an outer diameter substantially equal to an inner diameter of the cavity 66 of the shaft 22, only a very small assembly clearance being preferably retained. In addition, the retaining fingers 62 project radially outward from this plug body 64.

Each of the retaining fingers 62 is inserted into a second recess of the shaft 22, this second recess adopting the form of a second notch 144b opening circumferentially in one of the first notches 44b. Each second notch 144b may be of a dimension much smaller than that of the first notch 44b into which it opens, for example adopting the form of a simple notch in the circumferential direction.

More precisely, each second circumferential notch 144b is made in one of the two lateral sidewalls 68 of the first notch 44b into which it opens. In the preferred embodiment shown in FIG. 20, each second circumferential notch 144b (only one of the two notches 144b being visible in FIG. 20) is made at the axial bottom of the first associated notch 44b thereof.

Thus, in the ring-locking position 38 on the upstream end of the first shaft 22, each finger 44a circumferentially covers, at least partially, one of the second notches 144b housing a finger 62 retaining the plug. More specifically, each finger 44a covers, in the circumferential direction, the bottom of one of the second notches 144b housing a retaining finger 62.

Thanks to this overlap, each finger 44a therefore follows with a second notch 144b according to the circumferential direction, without these two elements necessarily being in contact with one another. In the event of circumferential clearance, the latter preferably remains sufficiently small to prevent the total extraction of the retaining finger 62 out of the second notch 144b.

FIG. 21 shows an axial view of the plug 60, the method of which for assembling it will now be described with reference to FIGS. 22 to 27.

Firstly, as can be seen in FIGS. 22, 23 and 25, a step is carried out of axially introducing the plug 60 into the cavity 66 of the first shaft 22, such that each retaining finger 62 of the plug is inserted axially downstream into the first associated notch 44b of the shaft 22 thereof, until reaching the axial bottom of this notch 44b.

Subsequently, the plug 60 is rotated along the axis X on which it is centered, so as to make each retaining finger 62 enter the second associated notch 144b thereof. The extent of the rotation may remain measured, in correlation with the shallow depth of the second notch 144b. FIGS. 24 and 26 show the system 120 after performing this step.

Finally, FIG. 27 illustrates the last step, corresponding to the axial movement of the locking ring 38 in the locking position thereof. This leads to introducing each finger 44a into the first associated notch 44b thereof of the shaft 22, until the finger 44a circumferentially covers, at least partially, the second notch 144b housing the retaining finger 62.

Of course, various modifications may be made by the person skilled in the art to the invention just described, only by way of non-limiting examples, and the scope of which is defined by the appended claims. In particular, the technical features of the various preferred embodiments and alternative embodiments thereof are interchangeable and/or combinable.

1. A system for locking a plug in a component of an aircraft turbine engine of axis, the component extending circumferentially about the axis,
wherein the system comprises a locking ring equipped with a projecting element, which, in a locking position of the locking ring, is intended to be inserted into a first recess of the turbine engine component, the first recess opening axially, the plug including a retaining finger intended to be inserted into a second recess of the component, the second recess adopting the form of a second notch opening circumferentially in the first recess,
and wherein the locking position of the locking ring in the turbine engine component, the projecting element of the locking ring is intended to circumferentially cover, at least partially, the second recess housing the retaining finger of the plug.

2. The locking system according to claim 1, wherein the locking ring of the plug forms an anti-rotation ring of a coupling system of the turbine engine component with another turbine engine component, being two turbine engine shafts, said anti-rotation ring being intended to limit/prevent the rotation of a tightening nut of the coupling system, and in that the projecting element of the locking ring is intended to cooperate with the first recess provided on the turbine engine component, so as to form together a first rotational coupling device.

3. The locking system according to claim 1, wherein the locking ring comprises two projecting elements, which, in a locking position of the locking ring, are respectively inserted into two first recesses of the component, the first recesses opening axially, the plug including two retaining fingers respectively configured to be inserted into the two second recesses of the turbine engine component, each of them circumferentially opening into one of the first recesses,
and wherein the locking position of the locking ring on the component, said at least two projecting elements of the locking ring circumferentially cover, at least partially, the two second recesses housing the retaining fingers.

4. The locking system according to claim 1, wherein the projecting element is a finger, and in that wherein the first recess of the turbine engine component is a first notch.

5. An aircraft turbine engine assembly comprising a component of an aircraft turbine engine that extends about the axis, a plug plugging a cavity of the component, as well as a system for locking the plug according to claim 1.

6. An assembly according to claim 5, wherein the assembly further comprises a system for coupling the component with another turbine engine component.

7. The assembly according to claim 5, wherein the plug comprises a body with an outer diameter substantially equal to an inner diameter of the cavity of the component to be plugged, and wherein the retaining finger of the plug projects radially outward from said plug body.

8. The assembly according to claim 5, wherein the second recess, which opens into the first recess, is a second circumferential notch made in one of the two lateral sidewalls of the first recess.

9. An aircraft turbine engine comprising at least one assembly according to claim 5.

10. A method for assembling a plug on a turbine engine component, with a system for locking a plug according to claim 1, the method comprising the following steps:
axially introducing the plug into a cavity of the component, such that the retaining finger of the plug is inserted into the first recess of the component;
rotating the plug so as to make the retaining finger thereof enter the second recess of the component;
axially moving the locking ring, so as to introduce the projecting element thereof into the first recess of the component, until the ring reaches the locking position thereof wherein the projecting element thereof circumferentially covers, at least partially, the second recess housing the retaining finger.
